(19) United States
(12) Patent Application Publication
(10) Pub. No.: US 2015/0214589 A1
(43) Pub. Date: Jul. 30, 2015

(54) RECHARGEABLE BATTERY

(71) Applicant: Imperial Innovations Limited, London (GB)

(72) Inventors: Nigel P. Brandon, Surrey (GB); Vladimir Yufit, London (GB)

(73) Assignee: Imperial Innovations Limited, London (GB)

(21) Appl. No.: 14/425,670

(22) PCT Filed: Sep. 6, 2013
(86) PCT No.: PCT/EP2013/068466

§ 371 Date: Mar. 4, 2015

(30) Foreign Application Priority Data
Sep. 7, 2012 (GB) 1215994.3

(51) Int. Cl. H01M 12/08; H01M 4/48; H01M 4/90; H01M 4/134; H01M 4/38

(52) U.S. Cl. CPC H01M 12/08; H01M 4/134; H01M 4/38; H01M 4/381; H01M 4/9033; H01M 4/48

(57) ABSTRACT

The present invention provides a rechargeable high temperature battery comprising a chamber defined by at least one wall formed at least in part as a solid membrane capable of passing oxide anions, and electrodes which are present on the inside and outside of the membrane that sandwich the membrane between them. The electrode on the outside of the chamber is an oxygen redox electrode, and the membrane exhibits good conductivity for the transport of oxide anions when it is at a temperature in the range of between about 500° C. and about 1000° C. The present invention also relates to a method of operating such a high temperature battery

### TECHNICAL FIELD

The present invention relates generally to the field of rechargeable battery technology.

### BACKGROUND

A shift from fossil-based energy generation towards utilisation of more renewable sources of energy requires introduction of energy storage devices. A number of technologies implementing mechanical to electrical energy conversion are able to store and deliver energy by using, for example, compressed air (CAES), pumped hydro (PHES) and flywheels. Other types of technologies implementing electrochemical energy storage are redox flow battery systems and high temperature sodium sulphur battery (NaS). For example, International patent application number WO2008/105811 discloses electrochemical cells and batteries for large-scale and commercial energy management which are able to deliver and receive electrical energy by simultaneous reversible electrochemical metal extraction in a high-temperature, all-liquid system.

The NaS battery has proven to be a reliable energy storage technology that can be scaled up to megawatt power levels. However there are some intrinsic issues that are likely to impede widespread adoption of this type of storage. For example, in order for the battery to operate, both sodium and sulphur must be in molten form. Temperature gradients within the sulphur electrolyte or battery shutdown can cause solidification of sulphur which must then be melted again. Furthermore, the high temperature sodium polysulphides, which are formed during the discharge of the battery, are extremely corrosive both for cathode (sulphur) current collectors and seals.

Another major issue with the NaS battery is one of safety. If the two electrolytes come in to contact (e.g. via failure of the ceramic separator) or one of electrolytes comes into contact with air surrounding the cell, an extremely vigorous reaction will occur, forming toxic gases such as hydrogen sulphide and sulphur oxides.

It is important to realise that rechargeable (or secondary) batteries are distinct to non-rechargeable (or primary) batteries, and as such, encounter different technical problems. Primary (or non-rechargeable) batteries consume fuel and can normally only be run in a power delivery mode; they either cannot be run in a storage mode (in which power is stored) or, if they can, they can only do so in a highly inefficient way. Furthermore, reversing the electrochemical reaction in a non-rechargeable battery can cause permanent damage to battery electrodes and even lead to battery failure. Non-rechargeable batteries are optimised for operating in the energy generating mode only while rechargeable batteries are optimised for the combined power delivery mode and the energy storage mode. Thus only electrochemical reactions that are readily reversible and materials for them can be used in a rechargeable battery, while in non-rechargeable batteries the reactions need not be reversible and indeed they are usually not. Because of these considerations, rechargeable batteries will normally use different electrochemical reactions and materials, as compared to non-rechargeable batteries and indeed the selection of such electrochemical reactions represents a distinct challenge to the person skilled in the art.

The present invention aims to reduce the safety risks associated with high temperature batteries employing molten chalcogenides and alkali metals, namely NaS batteries, which are known in the art, provide a simpler and more robust cell design and offer increased cycle life even at high depths of discharge.

### BRIEF DESCRIPTION OF THE DRAWINGS

FIG. 1 shows a phase diagram of a K—K₂O system (F. Natola and P. Touzain, Can. J. Chem., 48 (13), 1970, p1955-1958).

FIG. 2 shows a phase diagram of a Na₂O—V₂O₅ system (R. C. Kerby and J. R. Wilson, Can. J. Chem., 51 [7], 1032-1040 (1973)).

FIG. 3 shows a phase diagram of a Li₂O—V₂O₅ system (A. Fotiev, M. P. Glazyrin, and N. V. Bausova, Russ. J. Inorg. Chem. (Engl. Transl.), 13 (7) 1007-1010 (1968)).

FIG. 4 shows a schematic representation of the electrochemical reactions which take place in the battery of the present invention

FIG. 5 is a schematic of an exemplary battery according to the present invention.

FIG. 6 is a schematic of an exemplary battery module according to the present invention.

### DISCLOSURE OF THE INVENTION

The present invention is defined in the accompanying claims.

The present invention relates to a rechargeable battery, that is to say an electrochemical apparatus configured for both energy storage and power delivery and has a chamber defined by at least one wall formed at least in part as a solid membrane capable of passing oxide anions. Electrodes are present on the inside and outside of the membrane that sandwich the membrane between them. The electrode on the outside of the chamber is an oxygen redox electrode. Depending on the material used for the membrane, the membrane exhibits good conductivity for the transport of oxide anions when it is at a temperature in the range of between about 500° C. and about 1000° C.

In accordance with standard terminology in the field of batteries, the terms “anode” and “cathode” are defined by the functions of the electrodes in the battery's power delivery mode. To avoid confusion, the same terms are maintained to denote the same electrodes throughout the two modes of operation (power deliver and energy storage) of the rechargeable battery.

The electrochemical reactions will normally take place at or near the interfaces between the solid membrane, the electrode, and either the molten material comprising the metal/metal oxide or the source of oxygen. The electrodes may comprise anodic and cathodic current collectors that are used to supply electrons between an electrode and an external circuit; in the power delivery mode, the anodic current collector will transfer electrons away from the anode to the external circuit, and the cathodic current collector will supply electrons from the external circuit to the cathode. In the energy storage mode, the direction of electron flow at the current collectors will be reversed.

In a power delivery mode, an electrochemically active species (the metal) is oxidised at the electrode (the anode) disposed in the chamber, and an electrochemically active species (oxygen) is reduced at the electrode disposed on the external surface of the solid membrane (the cathode). In the energy storage mode, the electrochemical system is reversed and the metal oxide species is electrochemically reduced to the metal at the electrode disposed in the chamber and oxide ions are oxidised at the electrode disposed on the external surface of the solid membrane to regenerate oxygen gas. In both modes, oxide ions are transported across the membrane.

Therefore, in accordance with the present invention, there is provided a rechargeable battery comprising:

a) a chamber defined by at least one wall formed at least in part as a solid membrane capable of passing oxide anions when the solid membrane is at a temperature of between about 500° C. and about 1000° C.,
b) an electrode disposed in the chamber on the surface of the solid membrane,
c) an electrode disposed on the external surface of the solid membrane and capable of catalysing the reversible reaction:

O₂+4e⁻ [symbol] 2O²⁻

and
d) a material comprising a metal and/or at least one corresponding oxide of the metal contained within the chamber, wherein the material, both when containing the metal and the corresponding oxide of the metal, is molten at a temperature within the range of between about 500° C. and about 1000° C., and wherein the oxide is capable of being electrochemically reduced, and the metal is capable of being electrochemically oxidised, at the electrode disposed in the chamber operating at a temperature at which the material is molten.

As the battery of the invention only uses one very reactive component (the metal), the battery is intrinsically safer than other high temperature batteries known in the art (i.e. NaS).

In certain embodiments, the metal may be selected from the group consisting of potassium, sodium, lithium, bismuth, antimony or cadmium (and as such, the corresponding metal oxide will be potassium oxide, sodium oxide, lithium oxide, bismuth oxide, antimony oxide and cadmium oxide, respectively). In preferred embodiments, the metal is potassium, sodium, lithium or bismuth. More preferably, the metal is potassium or bismuth. In particularly preferred embodiments, the metal is potassium.

When the metal is potassium, the following reactions may occur during discharge of the battery:

TABLE 1
Various potassium oxides and their electrochemical characteristics

| | E.M.F at | Specific energy | Energy density (per |
|---|---|---|---|
| Reaction | 700° C. [V] | [Wh/kg] | oxide vol.) [Wh/l] |
| K + O₂ → KO₂ | 1.90 | 716 | 1546 |
| 2K + O₂ → K₂O₂ | 1.75 | 854 | 1861 |
| 4K + O₂ → 2K₂O | 1.37 | 779 | 1831 |

As indicated by table 1, if the reaction proceeds via potassium peroxide (K₂O₂) formation, the battery will have a lower voltage compared to potassium superoxide (KO₂). However, the energy density and specific energy for potassium peroxide will be the highest possible and higher than that of the conventional high temperature sodium-sulphur battery (760 Wh/kg; Handbook of Battery Materials, edited by Claus Daniel and Jurge O. Besenhard, 2^{nd} edition, 2011).

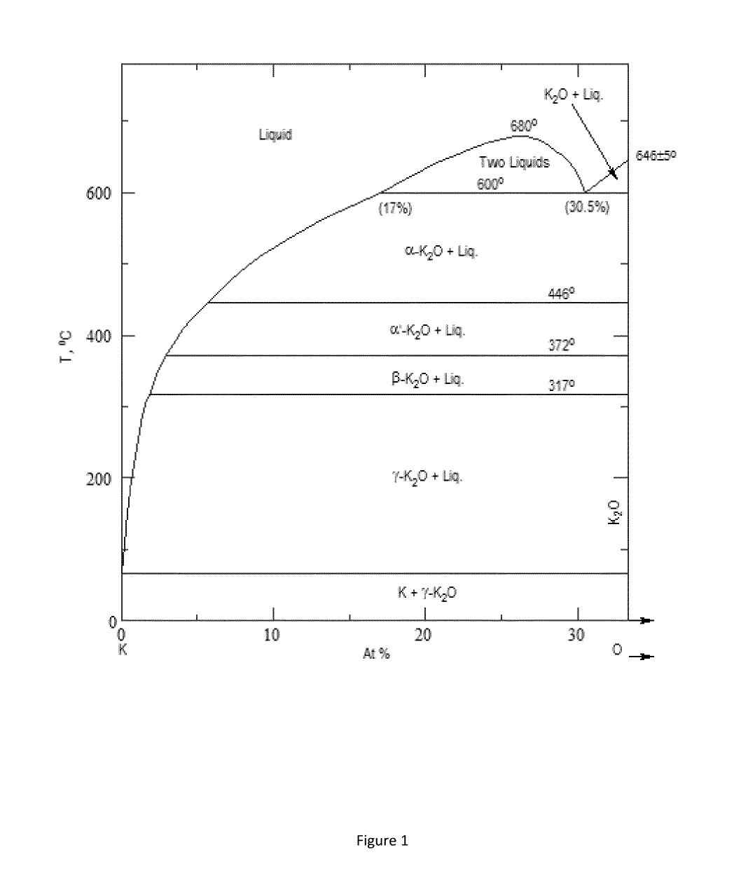

It will be appreciated by the skilled person that the metal may have more than one corresponding oxide. The presence and amount of each oxide in the chamber will depend on the temperature at which the battery is operated. If the metal has more than one corresponding oxide, the material comprising each of the metal oxides formed at the operational temperature of the battery must be molten, i.e. the material including the relevant oxides must be molten at a temperature in the range of between about 500° C. and about 1000° C. For example, Table 2 below shows that potassium oxide may exist as K₂O, KO₂ or K₂O₂. It should be noted that potassium monoxide has the highest melting point among various potassium oxides. The phase diagram in FIG. 1 shows various phases and melting points of potassium and its corresponding oxides (from F. Natola and P. Touzain, Can. J. Chem., 48 (13), 1970, p1955-1958). According to this phase diagram, potassium monoxide should be completely molten at 700° C. However, the true melting point will likely be higher than indicated by the phase diagram due to the presence of impurities which may be introduced during manufacture and operation of the battery, meaning that the phase diagram is less reliable and can only provide a guide on the melting points and phases.

Table 2 sets out the physical properties of various metals and their corresponding oxides.

TABLE 2
Physical properties of some metals and their oxides

| | | Den- | | | Den- | ΔG_{f}⁰ | E.M.F. |
|---|---|---|---|---|---|---|---|
| Ele- | M.P. | sity | | M.P. | sity | [kJ/mol] at | [V] at |
| ment | [° C.] | [g/ml] | Oxide | [° C.] | [g/ml] | 1000 K | 1000 K |
| Ga | 29.8 | 5.91 | Ga₂O | 660 | — | — | — |
| | | | Ga₂O₃ | 1807 | 6.00 | — | — |
| K | 63.3 | 0.89 | KO₂ | 380 | 2.16 | −183.2 | 1.90 |
| | | | K₂O₂ | 490 | 2.18 | −338.8 | 1.75 |
| | | | K₂O | 740 | 2.35 | −264.3 | 1.37 |
| Na | 98 | 0.97 | NaO₂ | 552 | 2.20 | −163.0 | 1.69 |
| | | | Na₂O₂ | 675 | 2.80 | −360.7 | 1.87 |
| | | | Na₂O | 1134 | 2.27 | −322.1 | 1.67 |
| In | 156.8 | 7.31 | In₂O₃ | 1912 | 7.18 | — | — |
| Li | 180.7 | 0.53 | Li₂O₂ | 195 | 2.31 | −484.1 | 2.51 |
| | | | Li₂O | 1438 | 2.01 | −508.2 | 2.63 |
| Sn | 232.1 | 5.77 | SnO₂ | 1630 | 6.85 | — | — |
| | | | SnO | 1080 | 6.45 | — | — |
| Bi | 271.5 | 9.79 | Bi₂O₃ | 825 | 8.90 | −493.7 at | 1.7 at |
| | | | | | | 300 K | 300 K |
| | | | Bi₂O₄ | 305 | 5.60 | — | — |
| Cd | 321.2 | 8.69 | CdO | 950 | 8.15 | −228.7 at | 1.2 at |
| | | | | | | 300 K | 300 K |
| Zn | 419.7 | 7.13 | ZnO₂ | 150 | 1.57 | — | — |
| | | | ZnO | 1974 | 5.60 | — | — |
| Te | 449.6 | 6.23 | TeO₂ | 733 | 5.90 | — | ~0.6 at |
| | | | | | | | 300 K |
| | | | TeO₃ | 430 | 5.07 | — | — |
| Sb | 630.9 | 6.68 | Sb₂O₃ | 655 | 5.70 | — | ~1.1 at |
| | | | | | | | 300 K |
| | | | Sb₂O₅ | 380 | 3.78 | — | — |
| Mg | 650 | 1.74 | MgO | 2825 | 3.6 | — | — |
| Al | 660.2 | 2.7 | Al₂O₃ | 2053 | 3.97 | — | — |
| Ba | 729 | 3.62 | BaO | 1973 | 4.96 | — | — |
| Sr | 777 | 2.64 | SrO | 2531 | 5.1 | — | — |
| Ce | 798 | 6.77 | Ce₂O₃ | 2210 | 6.2 | — | — |
| | | | Ce₃O₄ | 2480 | 7.22 | — | — |
| Ca | 839 | 1.54 | CaO₂ | 200 | 2.9 | — | — |
| | | | CaO | 2613 | 3.34 | | |

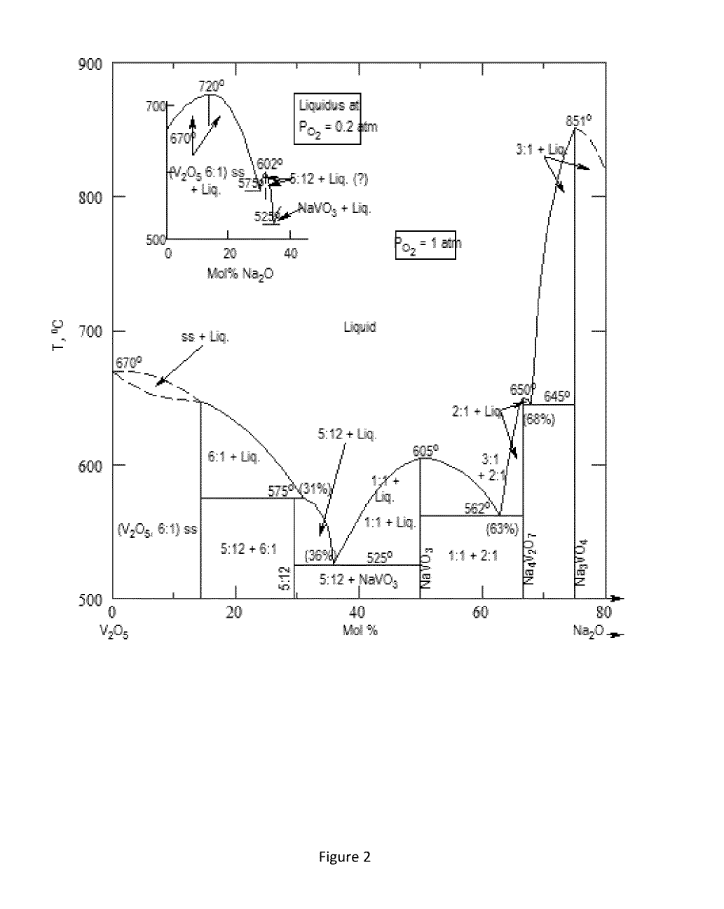

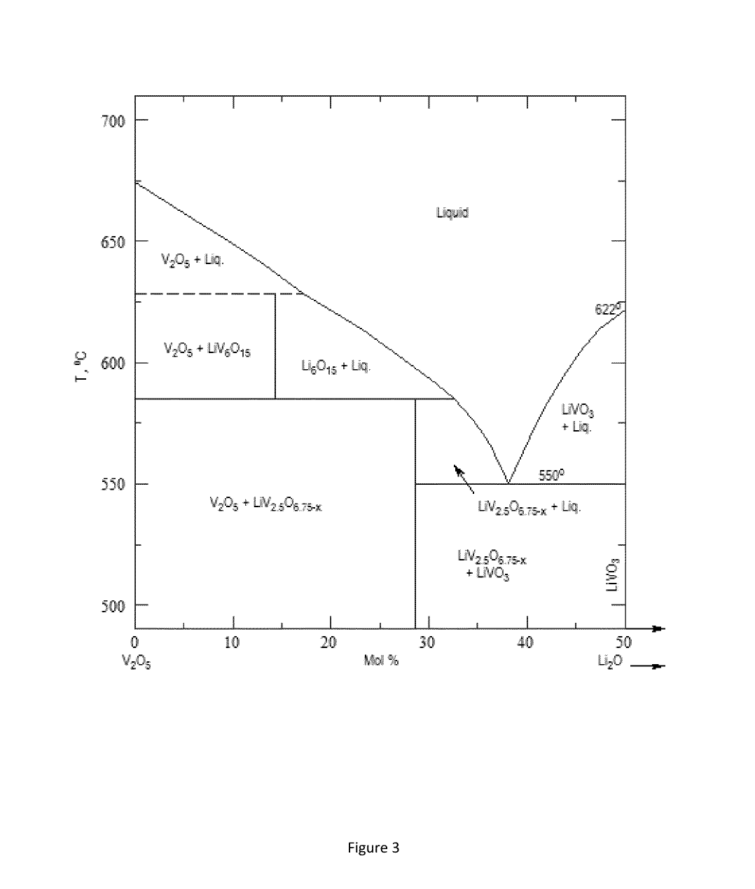

As set out above, the material containing each of the metal oxides present at the temperature of the battery must be molten at the operational temperature of the battery, which is in the range between about 500° C. and about 1000° C. Although lithium and sodium may form oxides which have melting points above 1000° C., by introducing one or more melting point lowering compounds into the material, such as vanadium pentoxide (V₂O₅), molybdenum trioxide (MoO₃), tungsten trioxide (WO₃) or boron trioxide (B₂O₃), the melting points of the material containing these oxides can be lowered, thereby allowing them to be used in the battery of the present invention. For example, the phase diagram of Na₂O—V₂O₅ (FIG. 2) and the phase diagram of Li₂O—V₂O₅ (FIG. 3) both show that the melting points of sodium oxide and lithium oxide can be lowered sufficiently by the addition of vanadium pentoxide to allow them to be used in the present invention. Therefore, when the metal is lithium or sodium, material containing the metal and/or its corresponding oxide comprises a melting point lowering compound, such as vanadium pentoxide, in an amount sufficient to lower the melting point of the metal oxide to a temperature in the range of about 500° C. to about 1000° C. The melting point lowering compounds are preferably electrochemically inert in the conditions of the present invention. The weight of melting point lowering compounds added should preferably not exceed the weight of the electrochemically active metal and/or its oxides. For example, the melting point lowering compound may be present in the material comprising a metal and/or a corresponding oxide of the metal in an amount of between about 0.1 to 50 wt %, preferably between about 10 to 30 wt %.

The melting point of the active material within the chamber, and especially, sodium oxide or lithium oxide may also be lowered by adding an element rather than a compound, e.g. a different metal, for example potassium, in an amount sufficient to lower the melting point of the metal oxide in the material to a temperature in the range of about 500° C. to about 1000° C. The melting point lowering element may be present in the material comprising a metal and/or a corresponding oxide of the metal in an amount of between about 0.1 to 50 wt %, preferably between about 10 to 30 wt %.

The rechargeable battery preferably has a high standard electrode potential (more than 1.2V). This means that, although tellurium and its corresponding oxides are all molten at a temperature within the range of between about 500° C. to about 1000° C., the standard electrode potential is likely to be very low at such temperatures, which means that the use of tellurium in the battery of the present invention is unlikely to be commercially viable.

Preferably, there is a difference between the density of the metal and that of its corresponding oxide(s) that is sufficient to allow the metal and its corresponding oxide(s) to separate into different phases. Phase separation may help avoid partial blockage of the electrode disposed in the chamber by reaction products.

It can be seen from table 2 above that the metals potassium, lithium and sodium have lower densities than their corresponding metal oxides. This means that when both the metal and its corresponding oxide(s) are present in the chamber, the metal will float on top of its corresponding oxide. When the metal is bismuth, cadmium or antimony, the corresponding metal oxide(s) will float on top of the metal, as the metals have a higher density than their corresponding oxide(s). Given that the volume of molten material will change during operation of the battery (due to the difference in densities of the metal and the corresponding oxide(s)), there may be an area which is not filled by the metal and/or its corresponding oxide(s) within the chamber (i.e. between the metal and/or corresponding oxide and the uppermost internal surface of the chamber). It will be appreciated that this area must not comprise any substances which may react with the metal and/or its corresponding oxide (such as oxygen gas). Therefore, this area may be evacuated or filled with an inert substance (such as argon gas) prior to sealing the chamber.

It will be appreciated that when the battery is fully charged, the predominant species in the chamber will be the metal. During power delivery, the metal is oxidised to form its corresponding metal oxide(s). Once the battery has been discharged, the predominant species in the chamber will be the corresponding metal oxide(s). During energy storage, the corresponding metal oxide(s) will be reduced to regenerate the metal species.

The electrode disposed inside the chamber is situated on, or sufficiently near to, the internal surface of the membrane to allow the oxide anions to migrate to and from the surface of the membrane to the anode. The electrode disposed inside the chamber is a porous electrode and is made of a material which is stable in the presence of both the metal and its corresponding oxide. Such materials are well known in the art. For example, the electrode may be made of a doped chromite, a doped titanate or an Inconel alloy. Alternatively, the electrode may be a porous composite of the solid membrane and the corresponding metal oxide, or a porous composite of the solid membrane and a metal having a melting point above 1000° C., preferably above about 1200° C., more preferably above about 1500° C. (for example, Inconel, or molybdenum).

The oxygen electrode on the outside of the chamber will also generally be a porous oxygen electrode of a known design based on solid oxide fuel cells (SOFCs) and be either a porous single phase mixed conductor such as Lanthanum Strontium Cobalt Iron Oxide (LSCF), or a porous composite of, for example, LSCF or Lanthanum strontium manganite (LSM) and the solid membrane. These materials can also be used as electrodes inside the chamber, thus simplifying the fabrication of the battery.

The solid membrane may be made of any material which is capable of passing oxide anions at a temperature of between about 500° C. and about 1000° C. Such materials are well known to the skilled person. For example, the solid membrane may be made from conducting ceramic materials such as doped zirconia (e.g. yttria stabilised zirconia (YSZ) or zirconia doped with scandia) or doped ceria (e.g. gadolinia doped ceria (GDC) or ceria doped with samaria). It will be appreciated that the choice of material will depend on the temperature at which the battery will be operated. For higher temperatures, such as about 700° C. to about 1000° C., the material may be yttria stabilised zirconia, for intermediate temperatures such as about 600° C. to about 750° C. the material may be scandia stabilised zirconia, while for lower temperatures, such as about 500° C. to about 600° C., the material may be gadolinia doped ceria.

The chamber may be of any shape or size and may comprise a sealable closure. For example, the chamber may be defined by a cylindrical wall and circular end caps. In certain embodiments, at least one of the circular end caps is a sealable closure. In preferred embodiments, the entire cylindrical wall is a solid membrane.

Either the entire chamber or the section of the chamber which comprises the solid membrane may be housed in a container. The container will allow a source of oxygen to circulate around the chamber, and have openings to allow the source of oxygen to enter the container.

The chamber is sealed in the sense that there should be no free movement of gas between the inside of the chamber and the atmosphere since the incursion of atmospheric gases into the chamber will cause chemical reactions with the molten electroactive species.

The electrode disposed on the external surface of the solid membrane (the cathode) is a porous electrode. Examples of suitable electrodes are well known in the art. The electrode must be capable of catalysing the following redox reaction:

O₂+4e⁻ [symbol] 2O²⁻

Such electrodes are well known in the art, for example, lanthanum strontium magnetite (LSM) or lanthanum strontium cobalt ferrite (LSCF), often in the form of a porous composite with the electrolyte material such as YSZ or GDC. Further examples of such electrodes are set out in Brett D R, et al, Chemical Society Reviews, 2008, Vol: 37, Pages: 1568-1578, the entire contents of which are hereby incorporated by reference.

During power delivery, oxygen must be present at the electrode disposed on the external surface of the solid membrane (the cathode). Any source of oxygen may be used, for example a pressurised oxygen source. In preferred embodiments, the source of oxygen is air, e.g. non-pressurised or pressurised air. If the source of oxygen is air, it will be appreciated that there is no need to store it in a vessel prior to use. The source of air may be supplied in any manner, for example, by exposing the rechargeable battery to the atmosphere or by supplying a stream of air to the battery's location, e.g. through a conduit. Circulation of the air through heat exchangers can be used as a means of controlling battery temperature.

In energy storage, oxygen will evolve from the cathode electrode disposed on the external surface of the solid membrane. The oxygen produced during energy storage may be able to be safely discharged to atmosphere, for example as oxygen enriched air, or if not, it can be collected for storage in a container, e.g. in a pressurised vessel.

The rechargeable battery may additionally comprise a heater which is capable of maintaining the rechargeable battery at a temperature of between about 500° C. and about 1000° C. In order to maintain the metal and/or its corresponding oxide in a molten state, the heater may be used both when the battery is in operation and when the battery is not in use (i.e. when the battery is in the charged or discharged state). The heater may be included within the battery apparatus, or may be separate from the assembly. During discharge, the battery may generate heat, which may be used to help maintain the operating temperature of the battery.

It will be appreciated by the skilled person that the temperature of the battery may vary with time, or it may vary along the battery's length. Furthermore, at one or more of the ends of the battery, the temperature may be below about 500° C. to about 1000° C. These areas are known as “cold zones” and do not affect the activity of the battery.

In some embodiments, individual rechargeable battery cells of the present invention can be connected in series or in parallel to one another.

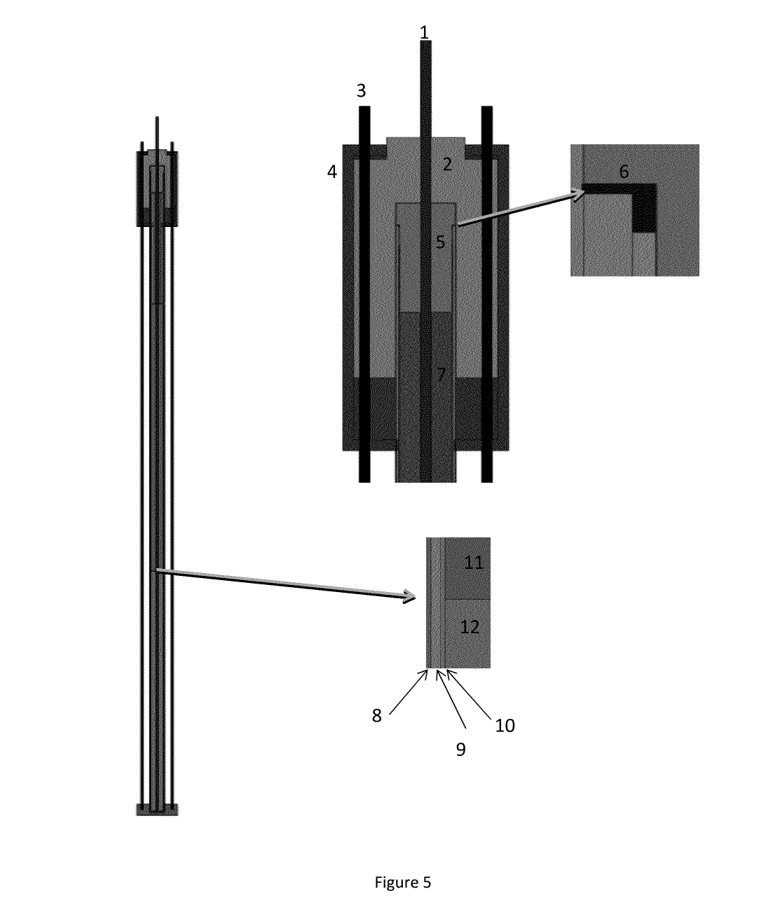

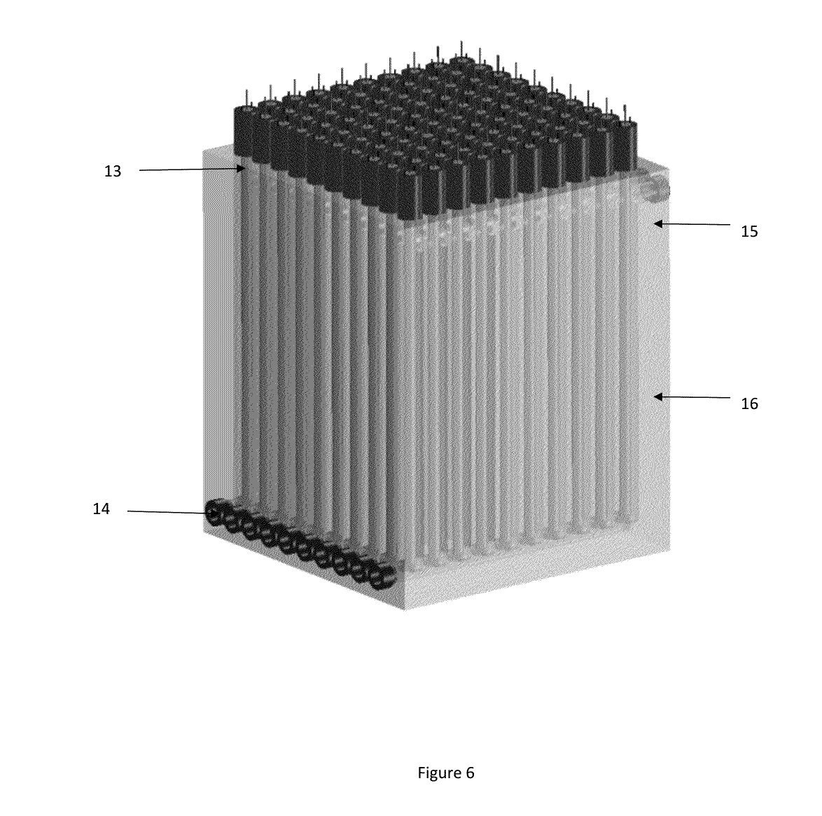

The rechargeable batteries of the invention may be made in a similar way to solid oxide fuel cells, which are well known in the art. For instance, the fuel cell may be tubular, or planar. For example, the chamber can either be manufactured as self supported tubes made of GDC or YSZ which are subsequently coated with anode and cathode layers, or the material which is to function as the membrane (i.e. the ceramic oxide anion conducting layer) is deposited as a thick film onto a cathode or anode support, followed by coating with the other electrode. Once the tube has been fabricated in a sintered form, and an anode current collector rod inserted if desired, the metal is introduced in solid form in a dry and oxygen free atmosphere. The tube is then sealed, and assembled, for example, as shown in FIG. 5. The battery may be interconnected in a multiplicity of parallel and series connections to form a battery module as shown in FIG. 6. The high temperature components may be thermally insulated to minimise heat losses to the environment. Heating elements may be included within the battery to raise its temperature to the operating level, and to maintain the temperature when needed. Air can also be circulated within the battery and peripheral balance of plant, such as heat exchangers, to control the battery temperature within set limits.

### Description of Embodiments and Examples

The present invention will now be described in further detail, by way of example only, by reference to the following drawings in which:

FIGS. 1, 2 and 3 show phase diagrams for a K—K₂O system, a Na₂O—V₂O₅ system and a Li₂O—V₂O₅ system respectively.

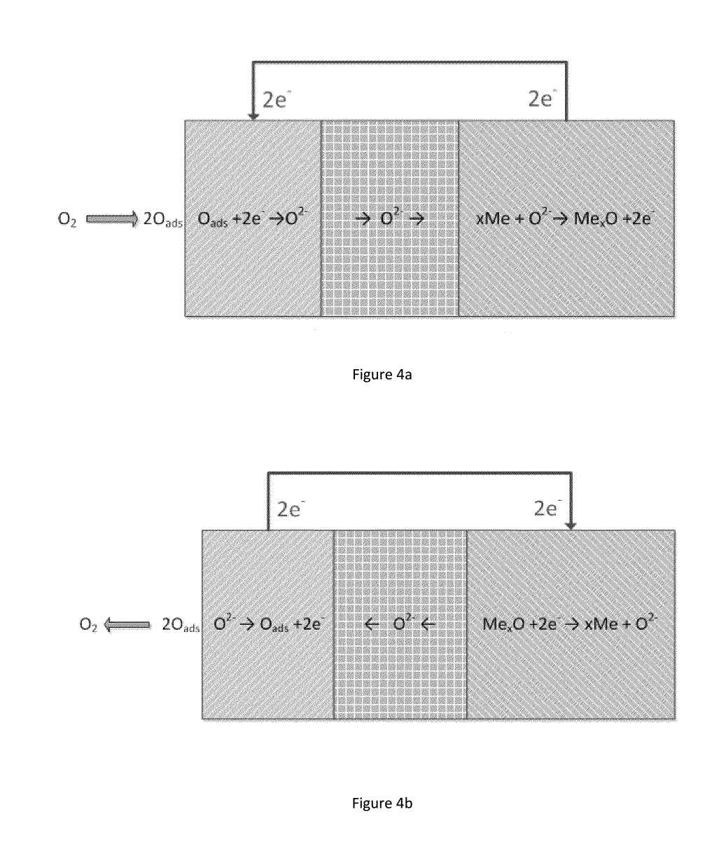

FIG. 4 is a schematic representation of the electrochemical reactions which take place in the battery of the present invention.

In the power delivery, or discharge, mode (FIG. 4a), a source of oxygen is supplied to the electrode on the external surface of the membrane. The oxygen is adsorbed (O_{ads}) onto the electrode surface and is reduced to an oxide anion (O²⁻) at, or close to, the interface between the solid membrane and the electrode disposed on the external surface of the solid membrane. The oxide anion is transported through the oxide anion conducting membrane to the internal surface of the membrane. The molten metal (Me) is oxidised to produce its corresponding molten metal oxide(s) (MeₓO_{y}) at the electrode disposed on the internal surface of the solid membrane and the current is collected by a current collector.

In the energy storage, or charging, mode (FIG. 4b), the system is reversed so that the molten metal oxide(s) (MeₓO_{y}) is reduced at the electrode disposed on the internal surface of the solid membrane to the molten metal (Me), and the oxide anions produced are transported through the solid membrane to the external surface of the solid membrane, where they are oxidised to oxygen (O_{ads}). The oxygen is then desorbed from the electrode disposed on the external surface of the membrane and the current collected by a current collector.

FIG. 5 shows a schematic of an exemplary battery according to the invention. The chamber (7) is typically tubular in shape and may be made entirely of a ceramic oxide ion conducting material (membrane). The anode current collector rod (1) will typically be made of metal alloys comprising chromium and nickel, such as Inconel, or molybdenum, which are able to withstand the corrosive environment of the molten metal and its corresponding oxide(s). It is attached to an anode current collector (5), which forms electrical contact inside the chamber. The end of the battery may be sealed, for example, with a ceramic insulator such as a glass ceramic (2). Examples of seals which may be used in the present invention are well known in the art, such as the seals set out in Mahapatra M K, Lu K, Mater. Sci. Eng., 2010; 67: 65-85. Supporting rods (3) may be present to provide compression to the sealed system, if necessary. The cathode current collector (4) is present to form electrical contact around the chamber. The anode current collector (5) and the chamber (7) may be sealed by a thermocompression (metal alloy) bond or by other means such as a glass ceramic seal (6). The cathode electroactive layer (8) is disposed on the external surface of the cylindrical wall of the chamber (9). The anode electroactive layer (10) is disposed on the internal surface of the cylindrical wall of the chamber (9) and provides a surface for the electrochemical reaction between the molten metal, its oxide(s), and oxide anions. The anode current collector rod (1) may be electrically connected to the anode electroactive layer through the molten metal (11). Alternatively, the anode current collector rod (1) may be in direct physical contact with the anode current collector rod (1), in which case the anode current collector rod (1) can be potentially shorter than the chamber (7). When the material in the chamber (7) comprises both the molten metal (11) and the molten corresponding oxide (12), if the metal is less dense than its corresponding oxide (e.g. potassium, lithium or sodium), the metal (11) will float on top of its oxide(s) (12) due to the lower density of the metal (11). It will be appreciated that when the metal is denser than its corresponding oxide, the corresponding oxide will float on top of the metal (e.g. bismuth, cadmium or antimony)

FIG. 6 shows a schematic representation of a battery module comprising a plurality of the batteries (13) shown in FIG. 5. The battery module comprises a container (16) which has a number of inlets (14) and outlets (15) which allow a source of oxygen, such as air, to be circulated around the plurality of batteries (13).

1. A rechargeable battery comprising:
a) a chamber defined by at least one wall formed at least in part as a solid membrane capable of passing oxide anions when the solid membrane is at a temperature of between about 500° C. and about 1000° C.,
b) an electrode disposed in the chamber on the surface of the solid membrane,
c) an electrode disposed on the external surface of the solid membrane and capable of catalysing the reversible reaction:
O₂+4e⁻ [symbol] 2O²⁻
and
d) a material comprising metal and/or at least one corresponding oxide of the metal contained within the chamber, wherein the material, when comprising one or both of the metal and the corresponding oxide of the metal, is molten at a temperature within the range of between about 500° C. and about 1000° C., and wherein the oxide is capable of being electrochemically reduced, and the metal is capable of being electrochemically oxidised, at the electrode disposed in the chamber operating at a temperature at which the material is molten.

2. The rechargeable battery according to claim 1, wherein the metal is potassium, antimony, cadmium or bismuth.

3. The rechargeable battery according to claim 1 or 2, wherein the metal is potassium.

4. The rechargeable battery according to any preceding claim, wherein the material contains at least one compound that lowers the melting point of the metal and its oxides.

5. The rechargeable battery according to claim 4, wherein the metal is lithium or sodium, and the chamber further includes at least one compound that lowers the melting point of the lithium or sodium and its oxides, e.g. vanadium pentoxide, molybdenum trioxide, tungsten trioxide or boron trioxide.

6. The rechargeable battery according to claim 4 or 5, wherein the at least one compound that lowers the melting point of the metal and its oxides is present in the material in an amount between about 0.1 to 50 wt %, preferably between about 10 to 30 wt %.

7. The rechargeable battery according to any preceding claim, further comprising a heater capable of maintaining the rechargeable battery at a temperature of between about 500° C. and about 1000° C.

8. A method of operating a rechargeable battery in a power delivery mode and in an energy storage mode at a temperature of between about 500° C. and about 1000° C., the cell comprising:
a) a chamber defined by at least one wall formed at least in part as a solid membrane capable of passing oxide anions when the solid electrolyte is at a temperature of between about 500° C. and about 1000° C.,
b) an electrode disposed in the chamber on the surface of the solid membrane,
c) an electrode disposed on an external surface of the solid membrane and capable of catalysing the reversible reaction:
O₂+4e⁻ [symbol] 2O²⁻
and
d) a material comprising a metal and/or a corresponding oxide of the metal contained within the chamber, wherein the material, when containing one and when containing both the metal and the corresponding oxide of the metal, is molten at a temperature within the range of between about 500° C. and about 1000° C., and wherein the method comprises, in said power delivery mode, exposing the electrode disposed on the external surface of the solid membrane to a source of oxygen to and, in said energy storage mode, applying a potential between the electrodes that is sufficient to reduce the metal oxide in the chamber to the metal.

9. The method according to claim 8, wherein the battery is as defined in any of claims 1 to 7.

10. The method according to claim 8 or 9, wherein the source of oxygen is air.
